(19) United States
(12) Patent Application Publication
(10) Pub. No.: US 2013/0198234 A1
(43) Pub. Date: Aug. 1, 2013

(54) Shared and Local Properties in a Multi-Hierarchy Taxonomy

(71) Applicants: Patrick Carl Miller, Sammamish, WA (US); Daniel E. Kogan, Sammamish, WA (US); Peter Blair Gonzalez del Solar, Bellevue, WA (US); Qinwei Zhu, Kirkland, WA (US)

(72) Inventors: Patrick Carl Miller, Sammamish, WA (US); Daniel E. Kogan, Sammamish, WA (US); Peter Blair Gonzalez del Solar, Bellevue, WA (US); Qinwei Zhu, Kirkland, WA (US)

(73) Assignee: Microsoft Corporation, Redmond, WA (US)

(21) Appl. No.: 13/607,174

(22) Filed: Sep. 7, 2012

Related U.S. Application Data
(60) Provisional application No. 61/591,185, filed on Jan. 26, 2012.

(51) Int. Cl. G06F 17/30

(52) U.S. Cl. 707/778; 707/E17.098

(57) ABSTRACT

Embodiments of the present disclosure provide a method and system for defining one or more custom properties of a term in a hierarchical taxonomy. Embodiments described herein include identifying a term in a term-set using an identifier associated with the term and defining at least one new property for the term. Once the property is defined, the newly defined property is applied to the term.

### PRIORITY

The present application claims priority to U.S. Provisional Patent Application No. 61/591,185 filed on Jan. 26, 2012. The aforementioned application is hereby incorporated by reference in its entirety.

### BACKGROUND

In large enterprises, and often in smaller companies, a corporate taxonomy exists that defines the hierarchical classification of entities of interest of the particular enterprise or company. The corporate taxonomy may also be used to classify documents, digital assets and other information. Typically, the corporate taxonomy is owned by a small number of people as any changes to the corporate taxonomy may effect various organizations within the enterprise or company. As such, a user is not able to further define items in the corporate taxonomy for local use.

It is with respect to these and other general considerations that embodiments have been made. Also, although relatively specific problems have been discussed, it should be understood that the embodiments should not be limited to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Embodiments of the present disclosure provide a method and system for defining one or more custom properties of a term in a hierarchical taxonomy. Embodiments described herein include identifying a term in a term-set using an identifier associated with the term and defining at least one new property for the term. Once the property is defined, the newly defined property is applied to the term.

Embodiments may be implemented as a computer process, a computing system or as an article of manufacture such as a computer program product or computer readable media. The computer program product may be computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following Figures in which:

FIG. 1 a system for accessing, maintaining, and editing a term store of a hierarchical taxonomy according to one or more embodiments;

FIG. 2 illustrates a method for defining one or more properties of a term in a hierarchical taxonomy according to one or more embodiments;

FIG. 3 illustrates a method for creating a new term-set having one or more terms according to one or more embodiments;

FIG. 4 illustrates a tablet computing device for executing one or more embodiments of the present disclosure;

FIG. 5 illustrates a block diagram of a computing environment suitable for implementing one or more embodiments disclosed herein;

FIG. 6A illustrates one embodiment of a mobile computing device executing one or more embodiments disclosed herein;

FIG. 6B is a simplified block diagram of an exemplary mobile computing device suitable for practicing one or more embodiments disclosed herein; and

FIG. 7 is a simplified block diagram of an exemplary distributed computing system suitable for practicing one or more embodiments disclosed herein.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

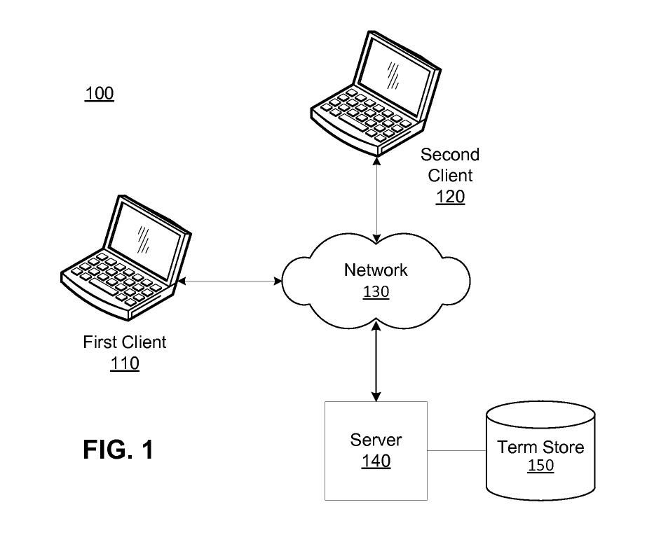

FIG. 1 illustrates a system 100 for accessing, maintaining, and editing a term store of a hierarchical taxonomy according to one or more embodiments. As shown in FIG. 1, the system 100 includes a first client 110 and a second client 120. In certain embodiments, the first client 110 and the second client 120 may access a server 140 over a network connection 130. Although two clients are shown, it is contemplated that fewer or additional clients may access the server 140 through the network connection 130. The server 140 maintains a term store 150 in which managed metadata is stored in the form of term-sets (e.g., a collection of terms that are arranged into and stored as a hierarchy) and terms. In certain embodiments, a term-set includes one or more terms that can be used as tags or categories. Additionally, each term may include one or more properties with each property having an associated value. In certain embodiments, a particular term may be reused in various term-sets. A term is reused when the term, or a property of that term, is associated with or has a membership in multiple locations or term-sets.

In certain embodiments, the association between a reused term or property and a new term-set is made by updating an identifier associated with the new term-set. For example, a table such as Table 2 below may store identifiers associated with each term or property. When the term or property is reused, the identifier for that term or property is associated the new term-set. When a term is reused, one or more embodiments provide that local custom properties associated with the particular term may also be reused.

In certain embodiments, a term property may be a local term property or a global term property. A global term property is a property that is associated with every instance of a term, regardless of which term-set the term is used in or reused in. In contrast, a local term property is a property that is associated with a term only in the context of the term-set in which it was applied to the term.

For example, consider two hypothetical groups: one called “Corporate Taxonomy” that has various term-sets and terms arranged in a hierarchy and another called “Marketing and Events” which includes a term-set and various terms. In the exemplary hierarchy displayed in below, a term to the right of another term is child of that term. For example, the term “North America” has three child terms “Canada”, “Mexico”, and “United States”. Additionally, the terms marked with an asterisk (*) may be expanded to show child terms of that particular term. Referring to the properties, the properties identified with a section symbol (§), are local properties, while those that are not marked as such are global properties. For example, the property “Population=500,000” is a global property and the property “Population=800,000” is a local property. As explained above and shown in the Table 1, each property has as associated value (e.g., the global “Population” property has a value of 500,000). Although properties are shown only for one term in the hierarchy, it is contemplated that each term in the hierarchy may have associated properties.

TABLE 1

| | | | | | |
|---|---|---|---|---|---|
| Term-set | Term | Term | Term | Term | Property |

Group = Corporate Taxonomy

| | | | | | |
|---|---|---|---|---|---|
| Geo- | | | | | |
| graphic | | | | | |
| Loca- | | | | | |
| tions | | | | | |
| | North | | | | |
| | America | | | | |
| | | Canada* | | | |
| | | Mexico* | | | |
| | | United | | | |
| | | States | | | |
| | | | California* | | |
| | | | Colorado* | | |
| | | | Washington | | |
| | | | | Seattle | Population = |
| | | | | | 500,000; City |
| | | | | | Manager = |
| | | | | | John Doe |
| | Europe* | | | | |
| | Asia* | | | | |
| Regional | | | | | |
| Sales | | | | | |
| Offices | | | | | |
| | Canada* | | | | |
| | United | | | | |
| | States | | | | |
| | | New York | | | |
| | | Washington | | | |
| | | | Seattle | | Population = |
| | | | | | 500,000; |
| | | | | | Population^{§} = |
| | | | | | 800,000; City |
| | | | | | Manager = |
| | | | | | John Doe; |
| | | | | | Sales |
| | | | | | Office^{§} = |
| | | | | | True |

Group = Marketing and Events

| | | | | | |
|---|---|---|---|---|---|
| Product | | | | | |
| Launch | | | | | |
| Events | | | | | |
| | North | | | | |
| | America | | | | |
| | | Canada* | | | |
| | | Mexico* | | | |
| | | United | | | |
| | | States | | | |
| | | | California* | | |
| | | | New York* | | |
| | | | Washington | | |
| | | | | Seattle | Population = |
| | | | | | 500,000; City |
| | | | | | Manager = |
| | | | | | John Doe; |
| | | | | | Launch |
| | | | | | Venue^{§} = |
| | | | | | Space Needle |
| | Europe* | | | | |
| | Asia* | | | | |

Referring to Table 1, if a user were to change a value of one or more global properties (e.g., a property that is not marked with the section symbol (§), on any instance of a term, the change would be reflected across all instances of the term. For example, if the user changed the global property “population” the change would be reflected across all three instances of the term “Seattle” (e.g., the term “Seattle” used in the “Geographical Locations” and “Regional Sales Offices,” term-sets in the “Corporate Taxonomy” group as well as the “Product Launch Events,” and term-set in the “Marketing and Events” group).

Continuing with the example above, although the term “Seattle” has a global property called “Population”, the reused instance of the term “Seattle” in the “Regional Sales Offices” term-set has a second property which is also called “Population”. However, as shown in Table 1, the second “Population” property has a value of 800,000. The new value for the second “Population” property may be changed due to the fact that while the population property of the “Corporate Taxonomy” group reflects the actual population of the city of Seattle, a regional sales office located in Seattle may want to alter the “Population” property in the “Regional Sales Offices” term-set because the regional sales office in Seattle sees the potential market in Seattle to encompass a much larger area and population than the legal geographic area of the city boundaries. As the second “Population” property is a local property, the edit to the local property does not affect other instances of the term “Seattle” that is used in other term-sets.

In another example, a client, such as, for example, the first client 110, may create a new term-set in a hierarchical taxonomy that uses the term “City” having a property and value pair of “Population=50,000”. The first client 110 may also add a second property (e.g., “City Manager=John Doe”) to the term “City”. In certain embodiments, the original term and property tuple (e.g., “City” and “Population=50,000”) may be global with respect to all terms in the hierarchical taxonomy while the “City Manager=John Doe” property is local with respect to the new term-set.

As discussed above, each term in the term store may be arranged in a hierarchical fashion. Accordingly, a first term may be a parent or child of another term and each child term may inherit one or more properties from the parent term. As each of the terms are organized into a hierarchical structure, changes to global properties may be sent through all terms. Additionally, changes to various parent-child relationships may also be propagated throughout the entire structure.

In certain embodiments, each level in the hierarchical taxonomy may be accessible by different clients. For example, if the hierarchical taxonomy is formatted as a tree structure, with each node in the tree representing a term, one client may have access to a first level of the tree, including all sub-nodes, while a second client may have access to a second level of the tree including all sub-nodes. As will be discussed below, the various nodes in the structure may be added, deleted or modified.

In certain embodiments, the term store 150 stores data about each individual term, term-set, term label, and term property. Such data may be stored in one or more tables of the term store 150. For example, the term store 150 may include a “Term” table that is populated with data about each term, such as, for example, an identifier for each term, with each row in the table representing a single term. The term store 150 may also include a “Term-Set” table that includes information about each term-set, such as, for example, an identifier associated with each term-set as well as a name of each term-set. In certain embodiments, the each row of the “Term-Set” table includes information about each term-set.

The term store 150 may also include a “Term Label” table that includes information corresponding to a value for a term. In certain embodiments, each row in the “Term Label” table represents one label of a term, with the term having an associated identifier (e.g., the term identifier in the “Term” table). The term store 150 may also include a “Term Property” table that is populated with term properties and term-set properties. Each property in the table has a property name and value. An exemplary “Term Property” table is included below:

TABLE 2

| Term ID | Term-Set ID | Property Name | Property Value |
|---|---|---|---|
| 1 | 0 | Property | Foo |
| 1 | 0 | SharedProperty | Everywhere |
| 1 | 3 | LocalProperty | Test1 |
| 1 | 3 | Property | Test2 |
| 1 | 4 | Local Property | TargetTest1 |
| 1 | 4 | Property | TargetTest2 |

In certain embodiments, the information in Table 2 may be used to determine which terms are associated with each term-set and which term properties are locally defined or globally defined. For example, as shown in Table 2, the rows with the Term ID as a 1 and a Term-Set Id as zero, represents a property for the term indicated by the Term ID and the property is shared among all instances of the term regardless of the term-set it appears in (e.g., the property is a global property). On the other hand, the rows with the Term Id as a 1 and the Term-Set ID as not zero represents a property for the term indicated by the Term ID and the property is local to the term-set indicated by the Term-Set ID. Thus, the client devices that have access to the term-set indicated by the Term-Set ID have access to the terms of the identified term-set. Although specific information is set forth above, it is contemplated that additional tables having additional data may be used to track global and local terms, term-sets and associated properties.

In certain embodiments, some properties associated with various terms may be reusable and/or customizable. For example, a property of a term may be defined by a user based on one or more preferences of the user. In another embodiment, a property of a term may be globally defined or set by an administrator. In such scenarios, the globally defined property may have one or more predefined values that are propagated across all instances of the term in the taxonomy. For example, a term “size” may have four associated globally defined properties of “Small”, “Medium”, “Large” and “Extra-Large”. Accordingly, when a term “size” is used in another term-set or group, the associated property of the term “size” is one of “Small”, “Medium”, “Large” or “Extra-Large.” In sum, certain property key may be predefined (e.g. the term name) and always associated with a term, whereas customizable properties may be defined by a user who may choose an arbitrary key name.

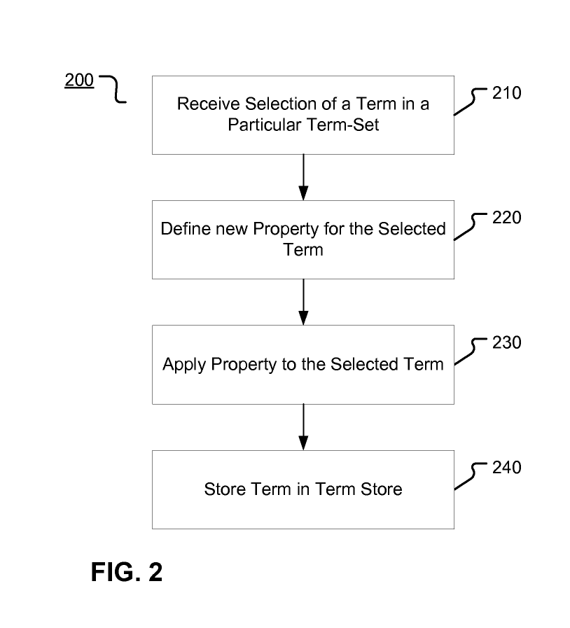

FIG. 2 illustrates a method 200 for defining one or more properties of a term in a hierarchical taxonomy according to one or more embodiments. Method 200 begins at operation 210 in which selection of a term in a hierarchical representation of term-sets is received. In certain embodiments, the term may be selected by a user of a client device that accesses a term management tool. The term management tool may be provided to a user of the client device to enable viewing and selection of various terms, term-sets and the like. Additionally, the term management tool may enable a user to search custom properties and synchronize custom properties across various local copies. The term management tool may also enable client device to provide information about local and global terms and the properties associated with each local and global term.

In certain embodiments, when the term is selected by the user, the client device transmits an identifier associated with the term to the term store. In certain embodiments, the identifier is the Term ID discussed above with respect to Table 2. In response to the request, the term store returns to the client a term object that is associated with the identifier.

Once the term has been selected and retrieved, flow proceeds to operation 220 in which new properties for the term are defined. In certain embodiments, the user of the client device may select a name of the property and a value of the property. Because the term and its associated property are defined by the client device, the term is deemed to be “owned” by the client device.

When the name and value of the term property has been set, the name and value are associated 230 with the term and the term is stored 240 in the term store. Although the addition of a term is specifically discussed above, it is contemplated that a user may, through a term management tool, add a new term-set, delete a term or term-set and the like. Regarding the deletion of a term, including a term that is being reused, embodiments provide that when a term is deleted, all global properties and local properties are also deleted.

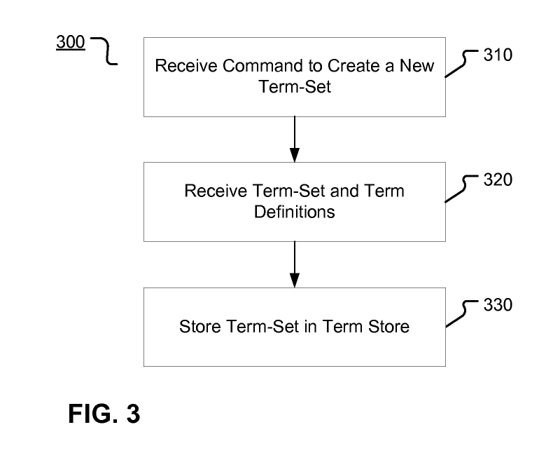

FIG. 3 illustrates a method 300 for creating a new term-set having one or more terms according to one or more embodiments. Once created, the term-set may be stored in a term store. As discussed above, the newly created term-set and/or the terms and properties in the term-set may be defined as local or global.

Method 300 begins at operation 310 in which a create term-set command is invoked by a client device. In certain embodiments, the command from the client device may be initiated based a user selection in term management tool. Once the command is invoked, a user may be prompted to define 320 a term-set name and one or more terms of the term-set. In certain embodiments, as each term is defined, one or more properties associated with each term is also defined. As discussed above, each term and term-set may also be assigned a corresponding identifier.

Once the term-set, terms, and properties associated with each term are defined, flow proceeds to operation 330 in which the term-set is stored in a term store, such as, for example, term store 150 (FIG. 1).

In certain embodiments, defining of local terms and properties as discussed herein may be used in web-based applications, such as, for example to define how a particular term is rendered on a given content site. Additionally, a term and its associated property may define how content aggregation is to occur using, for example, various ASPX pages.

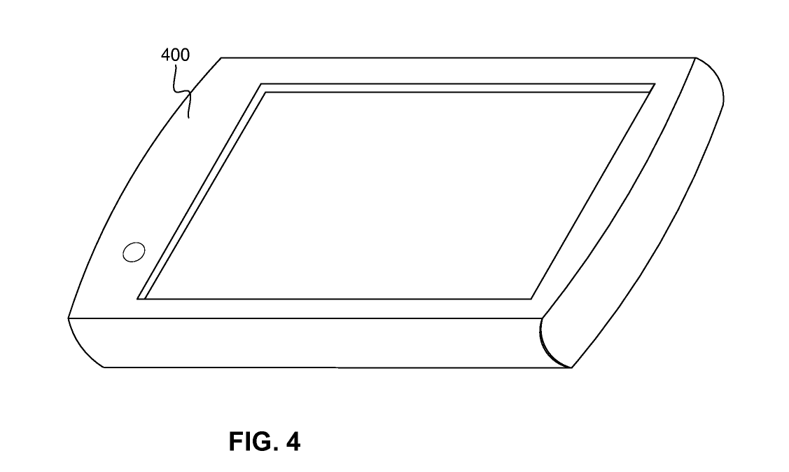

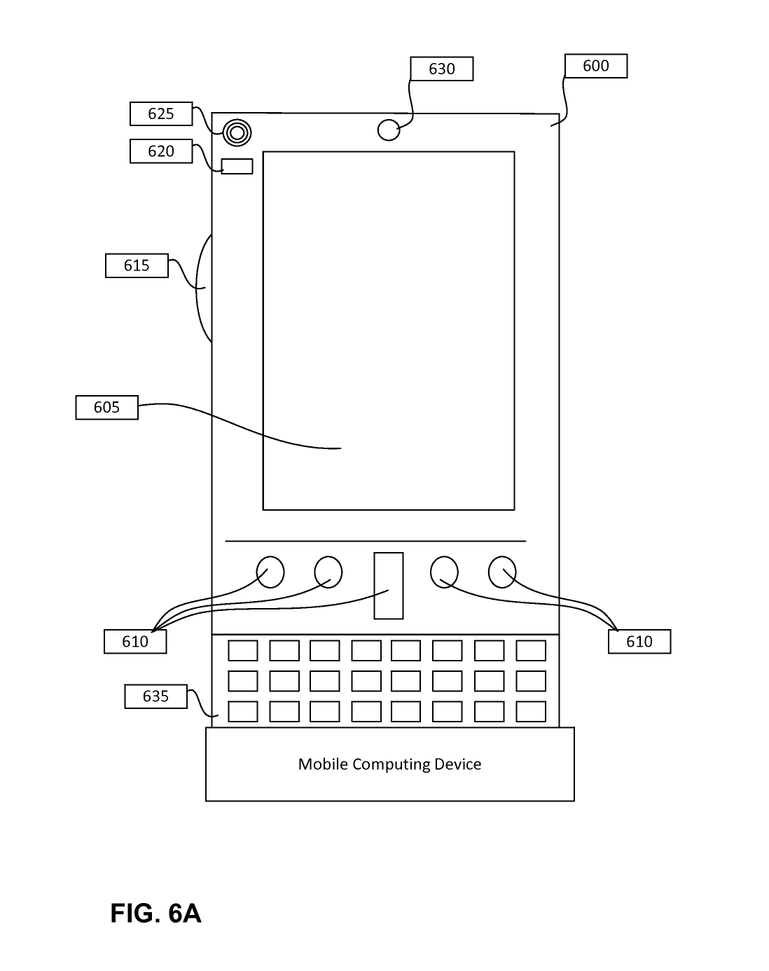

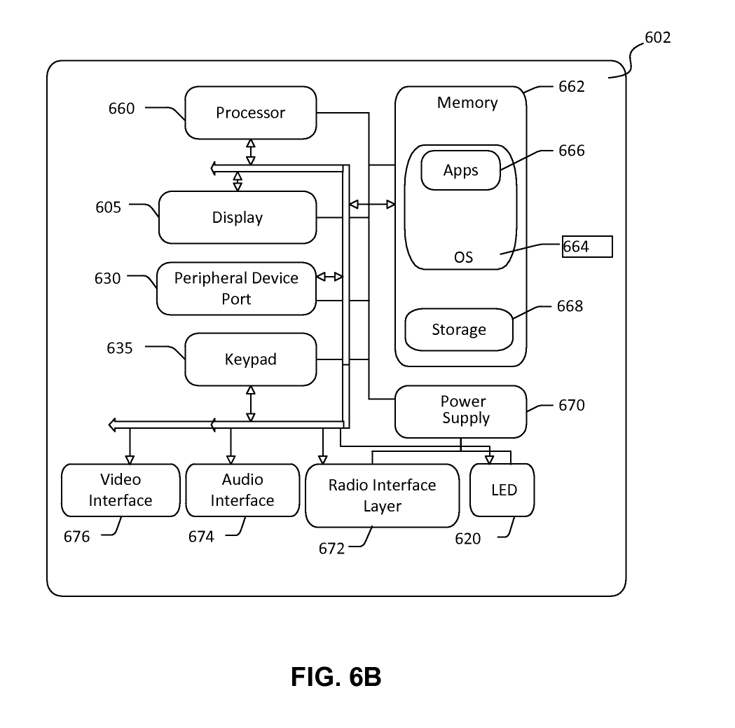

The embodiments and functionalities described herein may operate via a multitude of computing systems including, without limitation, wired and wireless computing systems, mobile computing systems (e.g., mobile telephones, netbooks, tablet or slate type computers, and laptop computers). FIG. 4 illustrates an exemplary tablet computing device 400 that may execute one or more embodiments disclosed herein. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 6 through 8 and the associated descriptions provide a discussion of a variety of operating environments in which embodiments of the present disclosure may be practiced. However, the devices and systems illustrated and discussed with respect to FIGS. 6 through 8 are for purposes of example and illustration and are not limiting of a vast number of computing device configurations that may be utilized for practicing embodiments of the present disclosure, described herein.

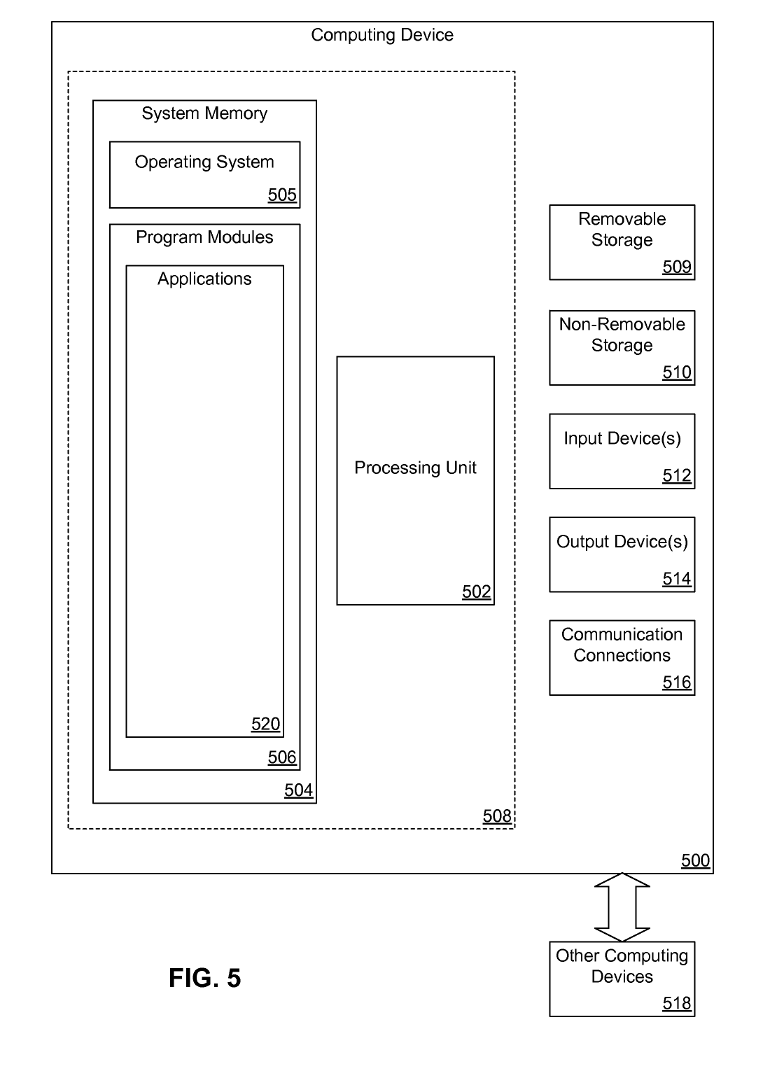

FIG. 5 is a block diagram illustrating exemplary physical components of a computing device 500 with which embodiments of the present disclosure may be practiced. The computing device components described below may be suitable for the computing devices described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination. The system memory 504 may include an operating system 505, one or more program modules 506, which are suitable for running applications 520. The operating system 505, for example, may be suitable for controlling the operation of the computing device 500. Furthermore, embodiments of the present disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including, for example, one or more of the stages of the methods described herein. The aforementioned process is an example, and the processing unit 502 may perform other processes. Other program modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the present disclosure, program modules may include routines, programs, components, data structures, and other types of structures that may perform particular tasks or that may implement particular abstract data types. Moreover, embodiments of the present disclosure may be practiced with other computer system configurations, including hand-held devices, multiprocessor systems, microprocessor-based or programmable consumer electronics, minicomputers, mainframe computers, and the like. Embodiments of the present disclosure may also be practiced in distributed computing environments where tasks are performed by remote processing devices that are linked through a communications network. In a distributed computing environment, program modules may be located in both local and remote memory storage devices.

Furthermore, embodiments of the present disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the present disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may be operated via application-specific logic integrated with other components of the computing device 500 on the single integrated circuit (chip). Embodiments of the present disclosure may also be practiced using other technologies capable of performing logical operations such as, for example, AND, OR, and NOT, including but not limited to mechanical, optical, fluidic, and quantum technologies. In addition, embodiments of the present disclosure may be practiced within a general purpose computer or in any other circuits or systems.

Embodiments of the present disclosure, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 504, the removable storage device 509, and the non-removable storage device 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 500. Any such computer storage media may be part of the computing device 500. The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The computing device 500 may include one or more communication connections 516 allowing communications with other computing devices 518. Examples of suitable communication connections 516 include, but are not limited to, RF transmitter, receiver, and/or transceiver circuitry; universal serial bus (USB), parallel, or serial ports, and other connections appropriate for use with the applicable computer readable media.

FIGS. 6A and 6B illustrate a mobile computing device 600, for example, a mobile telephone, a smart phone, a tablet personal computer, a laptop computer, and the like, with which embodiments of the present disclosure may be practiced. With reference to FIG. 6A, an exemplary mobile computing device 600 for implementing the embodiments is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

Although described herein in combination with the mobile computing device 600, in alternative embodiments, features of the present disclosure may be used in combination with any number of computer systems, such as desktop environments, laptop or notebook computer systems, multiprocessor systems, micro-processor based or programmable consumer electronics, network PCs, mini computers, main frame computers and the like. Embodiments of the present disclosure may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present disclosure.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a “smart phone” capable of running one or more applications (e.g., browser, e-mail, calendaring, contact managers, messaging clients, games, and media clients/players). In some embodiments, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world”, via a communications carrier or service provider. Transmissions to and from the radio 672 are conducted under control of the operating system 664. In other words, communications received by the radio 672 may be disseminated to the application programs 666 via the operating system 664, and vice versa.

The radio 672 allows the system 602 to communicate with other computing devices, such as over a network. The radio 672 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 602 provides notifications using the visual indicator 620 that can be used to provide visual notifications and/or an audio interface 674 producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668. Computer storage media may include volatile and nonvolatile, removable and non-removable media implemented in any method or technology for storage of information, such as computer readable instructions, data structures, program modules, or other data.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

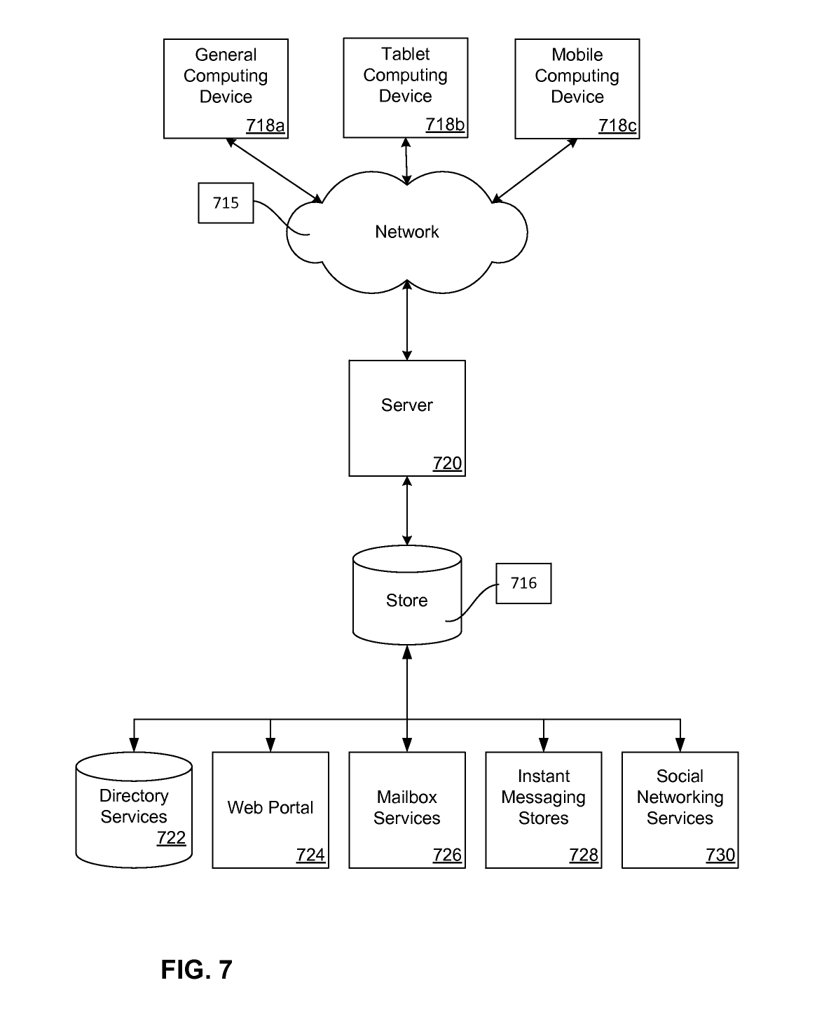

FIG. 7 illustrates one embodiment of the architecture of a system for providing converted documents to one or more client devices, as described above. In certain embodiments, the converted documents may be stored in different communication channels or other storage types. For example, various documents, including the converted documents, may be stored using a directory service 722, a web portal 724, a mailbox service 726, an instant messaging store 728, or a social networking site 730. The various components of the system 100 use any of these types of systems or the like for enabling data utilization, as described herein. A server 720 may provide the converted paragraphs to clients. The server 720 may provide the converted paragraphs and the status updates over the web to clients through a network 715. By way of example, the client computing device 718 may be implemented as the computing device 700 and embodied in a personal computer 718a, a tablet computing device 718b and/or a mobile computing device 718c (e.g., a smart phone). Any of these embodiments of the client computing device 718 may obtain content from the store 716. In various embodiments, the types of networks used for communication between the computing devices that make up the present disclosure include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

One skilled in the relevant art may recognize, however, that the embodiments may be practiced without one or more of the specific details, or with other methods, resources, materials, etc. In other instances, well known structures, resources, or operations have not been shown or described in detail merely to avoid obscuring aspects of the embodiments.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for defining one or more custom properties of a term in a hierarchical taxonomy, the method comprising:
identifying a term in a term-set using an identifier associated with the term;
defining at least one new property for the term; and
applying the at least one new property to the term.

2. The method of claim 1, further comprising propagating the at least one new property for the term across all term-sets in the hierarchical taxonomy when the property is defined as a global property.

3. The method of claim 1, further comprising enabling a second term-set in the hierarchical taxonomy to use the at least one new property when the at least one new property is defined as a local property.

4. The method of claim 3, wherein enabling a second term-set in the hierarchical taxonomy to use the at least one new property comprises associating the at least one property to the second term-set.

5. The method of claim 4, wherein associating the at least one property to the second term-set includes updating an identifier associated with the second term-set, the identifier indicating that the at least one property is associated with the second term-set.

6. The method of claim 3, wherein the local property is customizable.

7. The method of claim 1, wherein a first level of the term-set is only accessible by a first client device and wherein a second level of the term-set is accessible by the first client device and a second client device, wherein the first client device is different from the second client device.

8. A computer-readable storage medium encoding computer executable instructions that, when executed by one or more processors, perform a method for defining one or more custom properties of a term in a hierarchical taxonomy, the method comprising:
identifying a term in a term-set using an identifier associated with the term;
defining at least one new property for the term; and
applying the at least one new property to the term.

9. The computer-readable storage medium of claim 8, further comprising instructions for propagating the at least one new property for the term across all term-sets in the hierarchical taxonomy when the property is defined as a global property.

10. The computer-readable storage medium of claim 8, further comprising instructions for enabling a second term-set in the hierarchical taxonomy to use the at least one new property when the at least one new property is defined as a local property.

11. The computer-readable storage medium of claim 10, wherein enabling a second term-set in the hierarchical taxonomy to use the at least one new property comprises associating the at least one property to the second term-set.

12. The computer-readable storage medium of claim 11, wherein associating the at least one property to the second term-set includes updating an identifier associated with the second term-set, the identifier indicating that the at least one property is associated with the second term-set.

13. The computer-readable storage medium of claim 10, wherein the local property is customizable.

14. The computer-readable storage medium of claim 8, wherein a first level of the term-set is only accessible by a first client device and wherein a second level of the term-set is accessible by the first client device and a second client device, wherein the first client device is different from the second client device.

15. A system comprising:
one or more processors; and
a memory coupled to the one or more processors, the memory for storing instructions which, when executed by the one or more processors, cause the one or more processors to perform a method for defining one or more custom properties of a term in a hierarchical taxonomy, the method comprising:
identifying a term in a term-set using an identifier associated with the term;
defining at least one new property for the term, wherein the at least one new property is customizable and is defined as either: (i) a local property, or (ii) a global property; and
applying the at least one new property to the term.

16. The system of claim 15, further comprising instructions for propagating the at least one new property for the term across all term-sets in the hierarchical taxonomy when the property is defined as a global property.

17. The system of claim 15, further comprising instructions for enabling a second term-set in the hierarchical taxonomy to use the at least one new property when the at least one new property is defined as a local property.

18. The system of claim 17, wherein enabling a second term-set in the hierarchical taxonomy to use the at least one new property comprises associating the at least one property to the second term-set.

19. The system of claim 18, wherein associating the at least one property to the second term-set includes updating an identifier associated with the second term-set, the identifier indicating that the at least one property is associated with the second term-set.

20. The system of claim 15, wherein a first level of the term-set is only accessible by a first client device and wherein a second level of the term-set is accessible by the first client device and a second client device, wherein the first client device is different from the second client device.
